(19) United States
(12) Patent Application Publication
(10) Pub. No.: US 2016/0234415 A1
(43) Pub. Date: Aug. 11, 2016

(54) IMAGE CAPTURING DEVICE AND METHOD FOR IMAGE PROCESSING

(71) Applicant: Chicony Electronics Co., Ltd., New Taipei City (TW)

(72) Inventors: Wei-Cheng HUANG, New Taipei City (TW); Jin-Kae JANG, New Taipei City (TW)

(21) Appl. No.: 14/826,187

(22) Filed: Aug. 13, 2015

(30) Foreign Application Priority Data
Feb. 6, 2015 (CN) 201510063341.8

(51) Int. Cl. H04N 5/235; H04N 5/225; H04N 7/18; H04N 5/33

(52) U.S. Cl. CPC H04N 5/2351; H04N 5/33; H04N 5/2256; H04N 5/2354; H04N 7/183

(57) ABSTRACT

An image capturing device includes a case, a lens cover, a light source, an image capturing module, and a controller. The case and the lens cover integrally form an accommodating space. The light source is disposed in the accommodating space. The image capturing module is disposed in the accommodating space and configured to capture an image through the lens cover. The controller is electrically connected to the light source and the image capturing module. The controller obtains a result image by subtracting the brightness distribution of a built-in ghost image from the brightness distribution of the image.

### RELATED APPLICATIONS

This application claims priority to China Application Serial Number 201510063341.8, filed Feb. 6, 2015, which is herein incorporated by reference.

### BACKGROUND

1. Technical Field

The present disclosure relates to an image capturing device and methods for image processing.

2. Description of Related Art

Surveillance cameras are often used to monitor areas such as banks, casinos, airports, military bases, police stations and convenience stores. Surveillance camera systems can monitor different areas from a central control room. For some places are not suitable for monitoring by people, surveillance cameras can be installed to continuously monitor these places or monitor such areas for some specific conditions.

For low-light environment monitoring (e.g., night surveillance), surveillance cameras are typically used with infrared light sources. Because infrared light is invisible to the human eye, such monitoring with surveillance cameras can be performed without interfering the environment. Due to the fact, it is necessary to include cameras and light sources in such surveillance camera systems, the overall system becomes more complex than a usual camera.

### SUMMARY

This disclosure provides an image capturing device to simplify he overall structure of the image capturing device.

In one aspect of the disclosure, an image capturing device is provided. The image capturing device includes a case, a lens cover, a light source, an image capturing module, and a controller. The case and the lens cover integrally form an accommodating space. The light source is disposed in the accommodating space. The image capturing module is disposed in the accommodating space and configured to capture an image through the lens cover. The controller is electrically connected to the light source and the image capturing module. The controller obtains a result image by subtracting the brightness distribution of a built-in ghost image from the brightness distribution of the image.

In one or more embodiments, the light source is an infrared light source.

In another aspect of the disclosure, a method for image processing is provided. The method includes providing lighting by a light source disposed in an accommodating space formed by a case and a lens cover. Next, an image is captured by an image capturing module disposed in the accommodating space through the lens cover. Finally, a result image is obtained by subtracting the brightness distribution of a built-in ghost image from the brightness distribution of the image.

In one or more embodiments, the ghost image is obtained by multiplying the brightness distribution of a primitive ghost image by a specific number, and the specific number is determined by the exposure time, the film speed, and the aperture size of the image capturing module when the image capturing module is capturing the image.

In one or ore embodiments, the brightness contrast of the result image is increased after the result image is obtained.

In another aspect of the disclosure, a method for image processing is provided. The method includes providing an image capturing device is provided, in which a light source and an image capturing module of the image capturing device are disposed in an accommodating space formed by a case and a lens cover. Next, the image capturing device is moved, such that the lens cover faces a scene without reflectivity. Subsequently, the light source is turned on, after which a primitive ghost image is captured by the image capturing module through the lens cover. Finally, the primitive ghost image is saved in the image capturing device.

In one or more embodiments, the method further includes orienting the image capturing device to face an object. Next, an image is captured by the image capturing module through the lens cover. Finally, a result image is obtained by subtracting the brightness distribution of the primitive ghost image multiplied by a specific number from the brightness distribution of the image, in which the specific number is determined by the exposure time, the film speed, and the aperture size of the image capturing module when the image capturing module is capturing the image.

In one or more embodiments, the primitive ghost image is captured by the image capturing module when the light source is turned on and the lens cover faces a scene without reflectivity.

By the method for image processing of this disclosure, the light source and the image capturing module can be disposed in the same accommodating space. Therefore, the overall structure of the image capturing device becomes simple, and the light source can be fully protected by the case.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic perspective view of an image capturing device and an object according to one embodiment of this invention;

FIG. 2 is a flowchart of a method for image processing according to one embodiment of this invention;

FIG. 3A is a schematic view of an image according to one embodiment of this invention;

FIG. 3B is a schematic view of a ghost image according to one embodiment of this invention;

FIG. 3C is a schematic view of a result image according to one embodiment of this invention;

FIG. 4 is a flowchart of another method for image processing according to one embodiment of this invention; and

FIG. 5 is a schematic block diagram of a controller according to one embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

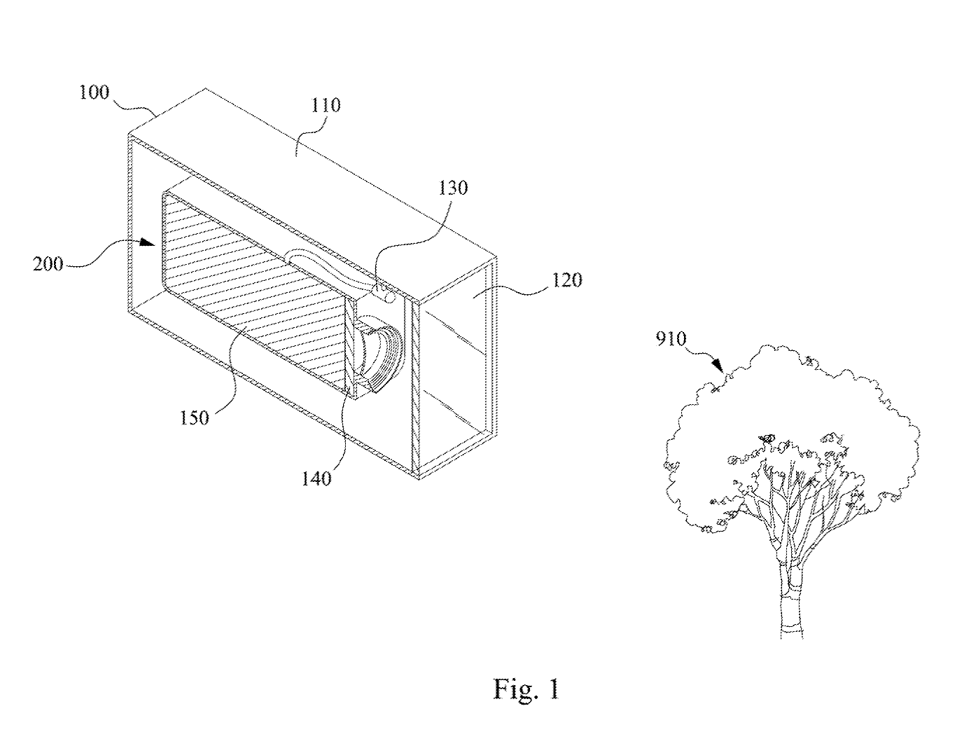

FIG. 1 is a schematic perspective view of an image capturing device 100 and an object 910 according to one embodiment of this invention. An image capturing device 100 is provided, and the image capturing device 100 can be a surveillance camera. Specifically, the image capturing device 100 can be a night surveillance camera to monitor specific areas at night (or to monitor low-light environments).

As shown in FIG. 1, the image capturing device 100 includes a case 110, a lens cover 120, a light source 130, an image capturing module 140, and a controller 150. The case 110 and the lens cover 120 integrally form an accommodating space 200. The light source 130 is disposed in the accommodating space 200. The image capturing module 140 is disposed in the accommodating space 200 and configured to capture an image through the lens cover 120. The controller 150 is electrically connected to the light source 130 and the image capturing module 140. The controller 150 obtains a result image by subtracting the brightness distribution of a built-in ghost image from the brightness distribution of the image captured by the image capturing module 140.

In a typical surveillance camera, the image capturing module and the light source are disposed in different accommodating spaces. For example, the image capturing module may be disposed in the accommodating space formed by the case and the lens cover, and the light source may be disposed outside the case. In another example, the image capturing module may be disposed in the accommodating space formed by the case and lens cover, and the light source may be disposed in another accommodating space formed by another case and another lens cover. In contrast to the aforementioned examples, the light source 130 and the image capturing module 140 of the image capturing device 100 of this disclosure are both disposed in the accommodating space 200. Therefore, the overall structure of the image capturing device 100 becomes simple, and the light source 130 can be fully protected by the case 110.

Specifically, because the light source 130 and the image capturing module 140 are both disposed in the accommodating space 200 instead of in two different accommodating spaces, a more integral and aesthetically pleasing external appearance for the image capturing device 100 is achieved. In addition, because the image capturing device 100 does not need an additional case and lens cover to form another accommodating space, the structure of the image capturing device 100 can be simplified and the material needed for manufacture of the image capturing device 100 is minimized. Therefore, the manufacturing cost of the image capturing device 100 is reduced.

The light source 130 can be an infrared light source. People having ordinary skill in the art can make proper modifications to the light source 130 depending on the actual application.

The image capturing module 140 can include a lens, a shutter, and a sensor. The detailed structure of the image capturing module 140 will not be described herein. The sensor can be a charge-coupled device (CCD) or a complementary metal-oxide-semiconductor (CMOS).

Since the structure of the image capturing device 100 is different from that of typical surveillance cameras, the image capturing device 100 needs to be operated using a special method for image processing. The method for image processing is described below.

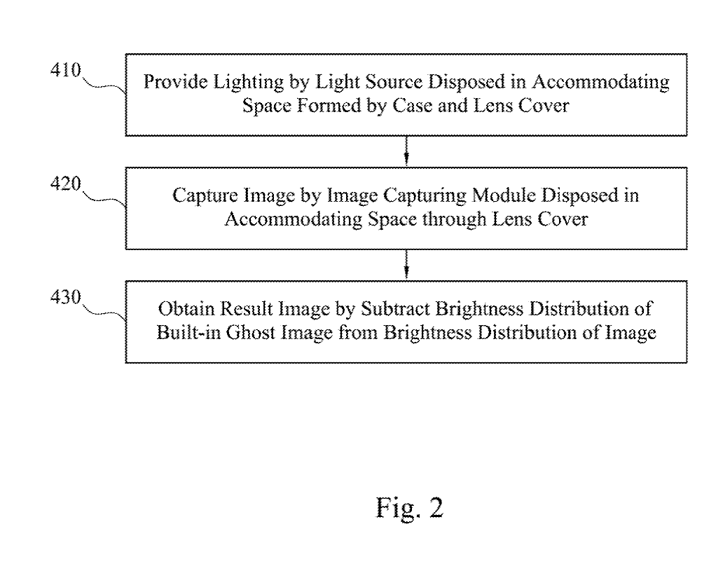

FIG. 2 is a flowchart of a method for image processing according to one embodiment of this invention. As shown in FIG. 1 and FIG. 2, at operation 410, lighting is provided by the light source 130 disposed in the accommodating space 200 formed by the case 110 and the lens cover 120.

At operation 420, an image is captured by the image capturing module 140 disposed in the accommodating space 200 through the lens cover 120.

At operation 430, a result image is obtained by subtracting the brightness distribution of a built-in ghost image from the brightness distribution of the image captured by the image capturing module 140.

Detailed information of the aforementioned operations is described below.

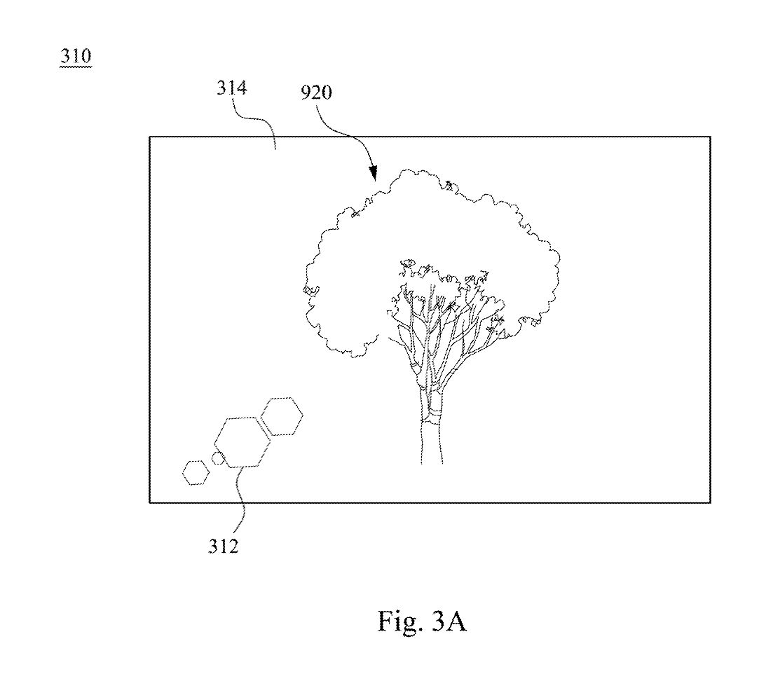

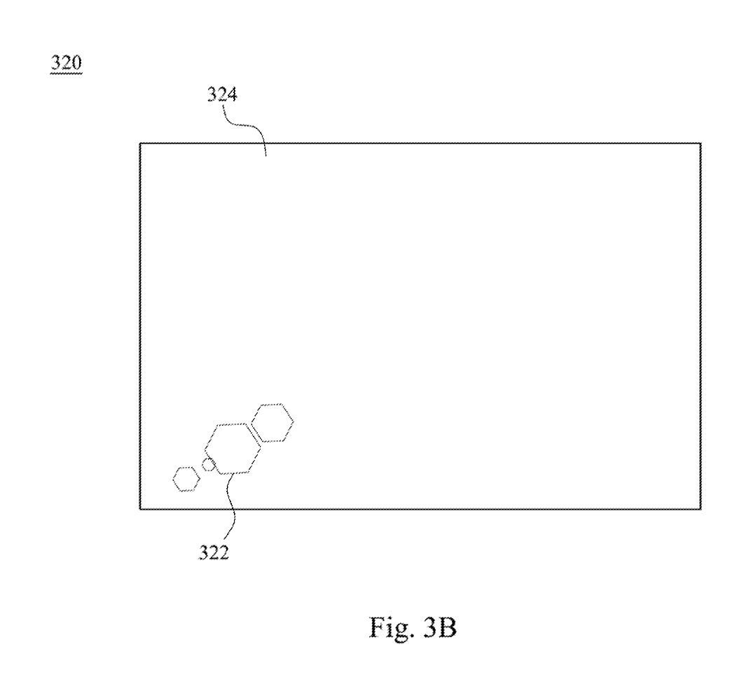

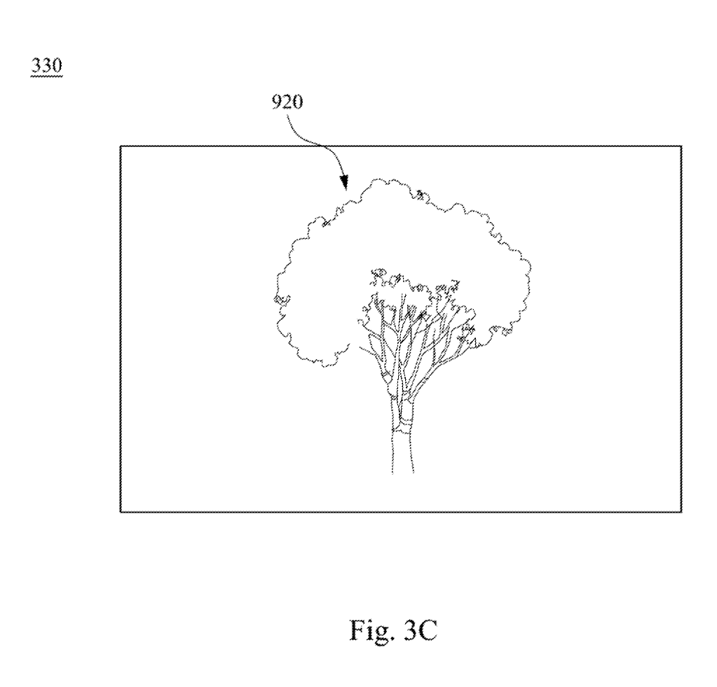

FIG. 3A is a schematic view of the image 310 captured by the image capturing module 140 according to one embodiment of this invention. As shown in FIG. 1 and FIG. 3A, at operation 420, specifically, the image capturing device 100 is facing an object 910. Next, the image capturing module 140 captures the image 310 through the lens cover 120. Because the image capturing device 100 faces the object 910 the image of the object 920 will be in the image 310. However, because the light source 130 and the image capturing module 140 are both disposed in the accommodating space 200, part of the light emitted by the light source 130 to the lens cover 120 will be reflected to the light capturing module 140, and thus at least one ghost 312 is formed in the image 310. Therefore, some regions in the image 310 are interfered with the ghost 312 and do not seem clear.

FIG. 3B is a schematic view of the ghost image 320 according to one embodiment of this invention. As shown in FIG. 3B, only the ghost 322 appears in the ghost image 320, and there are no other images of objects in the ghost image 320. In other words, the ghost image 320 is a superimposed image of a black image and the ghost 322. The ghost 322 in the ghost image 320 corresponds to the ghost 312 in the image 310 in FIG. 3A.

FIG. 3C is a schematic view of the result image 330 according to one embodiment of this invention. As shown in FIG. 3A to FIG. 3C, because the image 310 is interfered with the ghost 312 and becomes unclear, the method of image processing of this disclosure performs operation 430, which involves obtaining the result image 330 by subtracting the brightness distribution of the built-in ghost image 320 from the brightness distribution of the image 310. Because the ghost 322 in the ghost image 320 corresponds to the ghost 312 in the image 310, after the brightness distribution of the ghost image 320 is subtracted from the brightness distribution of the image 310, the result image 330 with only the image of the object 920 and without the interference of the ghost is obtained.

The ghost 322 in the ghost image 320 must correspond to the ghost 312 in the image 310, such that the result image 330 without the interference of the ghost can be obtained after image processing. Therefore, the ghost image 320 must be generated by a special method, which is described below.

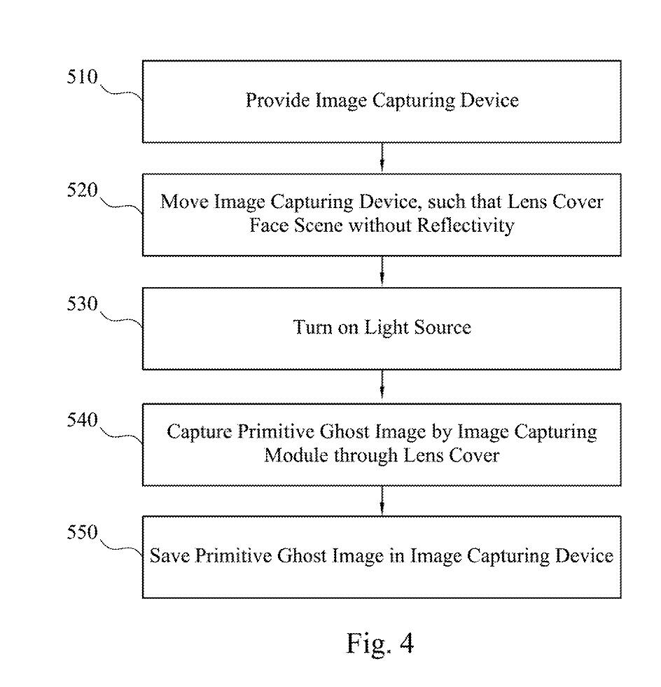

FIG. 4 is a flowchart of another method for image processing according to one embodiment of this invention. As shown in Fig, 1 and FIG. 4, at operation 510, the image capturing device 100 in FIG. 1 is provided, in which the light source 130 and the image capturing module 140 of the image capturing device 100 are both disposed in the accommodating space 200 formed by the case 110 and the lens cover 20.

At operation 520, the image capturing device 100 is moved, such that the lens cover 120 faces a scene without reflectivity. Specifically, a scene without reflectivity can be the night sky or a black curtain without reflectivity (the lens cover 120 faces the black curtain).

At operation 530, the light source 130 is turned on. Because the lens cover 120 faces a scene without reflectivity at this time, the light emitted by the light source 130 and passing through the lens cover 120 is not reflected back to the image capturing module 140, and only the light that is reflected by the lens cover 120 and which is also emitted by the light source 130 is emitted back to the image capturing module 140.

At operation 540, a primitive ghost image is captured by the image capturing module 140 through the lens cover 120. Related to the aforementioned description, the light reflected back to the image capturing module 140 by the lens cover 120 will form the ghost in the primitive ghost image, and there is no other light to form any other image in the primitive ghost image. Therefore, the primitive ghost image is a superimposed image of a black image and the ghost.

At operation 550, the primitive ghost image is saved in the image capturing device 100 for subsequent image processing.

As shown in FIG. 3A and FIG. 4, the primitive ghost image is captured by the image capturing module 140 when the light source 130 is turned on, and the image 310 is also captured by the image capturing module 140 when the light source 130 is turned on. Therefore, the optical states of the internal space of the image capturing device 100 (or the accommodating space 200) when the primitive ghost image is captured and when the image 310 is captured are approximately the same (compared with the optical state of the internal space of the image capturing device 100 when the primitive ghost image is captured, when the image 310 is captured, not only is there the light reflected by the lens cover 120, but there is also the light reflected from the ambient environment to form the image of the ambient environment such as the image of the object 920). Therefore, the ghost in the primitive ghost image corresponds to the ghost 312 in the image 310.

As shown in FIG. 1, after the primitive ghost image is generated, the image capturing device 100 can capture the image of the ambient environment such as the object 910 and perform the method for image processing as shown FIG. 2.

As show in FIG. 1 and FIG. 3A to FIG. 3C, when the image capturing module 140 is capturing the primitive ghost image and the image 310, the parameters may not be the same, i.e., the exposure time, the film speed (ISO), and the aperture size of the image capturing module 140 may not be the same when the image capturing module 140 is capturing the primitive ghost image and the image 310. Therefore, when operation 430 of FIG. 2 is performed, the ghost image 320 is obtained by multiplying the brightness distribution of the primitive ghost image by a specific number, in which the specific number is determined by the exposure time, the film speed (ISO), and the aperture size of the image capturing module 140 when the image capturing module 140 is capturing the primitive ghost image and the image 310. Subsequently, the result image 330 is obtained by subtracting the brightness distribution of the ghost image 320 from the brightness distribution of the image 310.

For example, when the image capturing module 140 is capturing the primitive ghost image, the film speed (ISO) is 100, and the exposure time is one-fifteenth of a second. Moreover, when the image capturing module 140 is capturing the image 310, the film speed (ISO) is 100, and the exposure time is one-thirtieth of a second. Therefore, the ghost image 320 is obtained by multiplying the brightness distribution of the primitive ghost image by two (the image capturing module 140 basically does not change aperture size, so the aperture size is assumed to be a constant). In another example, when the image capturing module 140 is capturing the primitive ghost image, the film speed (ISO) is 100, and the exposure time is one-fifteenth of a second. Moreover, when the image capturing module 140 is capturing the image 310, the film speed (ISO) is 200, and the exposure time is one-thirtieth of a second. Therefore, the ghost image 320 is obtained by multiplying the brightness distribution of the primitive ghost image by one.

Furthermore, when the image capturing module 140 is capturing the primitive ghost image or the image 310, in addition to the ghost with a specific pattern formed by the light reflected to the image capturing module 140 by the lens cover 120 and emitted from the light source 130, a flare is also formed, which is evenly distributed in the entire primitive ghost image or the image 310. Because the ghost image 320 is obtained by multiplying the brightness distribution of the primitive ghost mage by a specific number, the brightness of the flare 324 in the ghost image 320 may not be the same as the brightness of the flare 314 in the image 310. After the brightness distribution of the ghost image 320 is subtracted from the brightness distribution of the image 310, the brightness contrast of the result image 330 is usually less than the brightness contrast of the image 310. Therefore, it is preferred to increase the brightness contrast of the result image 330 by the controller 150 (see FIG. 1) after the result image 330 is obtained, such that the brightness contrasts of the result image 330 and the image 310 can be approximately the same.

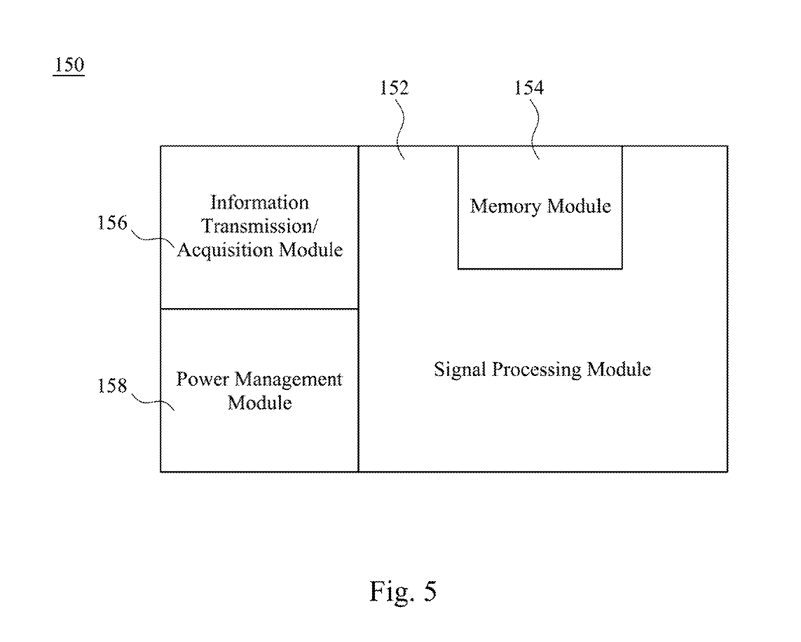

FIG. 5 is a schematic block diagram of the controller 150 according to one embodiment of this invention. As shown in FIG. 5, the controller 150 includes a signal processing module 152, a memory module 154, an information transmission/ acquisition module 156, and power management module 158. Each of the memory module 154, the information transmission/ acquisition module 156, and power management module 158 is electrically connected to the signal processing module 152.

The signal processing module 152 may be a digital signal processor (DSP). People having ordinary skill in the art can make proper modifications to the signal processing module 152 depending on the actual application.

The memory module 154 may be a random access memory (RAM), a flash memory, or a memory card. More specifically, the memory card may be a secure digital memory card.

The information transmission/ acquisition module 156 may be a wired module, such as a universal serial bus (USB) module, or a wireless module, such as a Bluetooth module or a radio module complying with a Wi-Fi standard.

The power management module 158 may be a power management unit. People having ordinary skill in the art can make proper modifications to the power management module 158 depending on the actual application.

By selecting different embodiments of the signal processing module 152, the memory module 154, the information transmission/ acquisition module 156 and the power management module 158, the image capturing device 100 can be flexibly applied to different environments.

By the method for image processing of this disclosure, the light source 130 and the image capturing module 140 can be disposed in the same accommodating space 200. Therefore, the overall structure of the image capturing device 100 becomes simple, and the light source 130 can be fully protected by the case 110.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An image capturing device, comprising:
a case;
a lens cover, wherein the case and the lens cover integrally form an accommodating space;
a light source disposed in the accommodating space;
an image capturing module disposed in the accommodating space configured to capture an image through the lens cover; and
a controller electrically connected to the light source and the image capturing module, wherein the controller obtains a result image by subtracting the brightness distribution of a built-in ghost image from the brightness distribution of the image.

2. The image capturing device of claim 1, wherein the light source is an infrared light source.

3. The image capturing device of claim 1, wherein the ghost image is obtained by multiplying the brightness distribution of a primitive ghost image by a specific number, and the specific number is determined by the exposure time, the film speed, and the aperture size of the image capturing module when the image capturing module is capturing the image.

4. The image capturing device of claim 1, wherein the controller is configured to increase the brightness contrast of the result image after the result image is obtained.

5. A method for image processing, comprising:
providing lighting by a light source disposed in an accommodating space formed by a case and a lens cover;
capturing an image by an image capturing module disposed in the accommodating space through the lens cover; and
obtaining a result image by subtracting the brightness distribution of a built-in ghost image from the brightness distribution of the image.

6. The method for image processing of claim 5, wherein the light source is an infrared light source.

7. The method for image processing of claim 5, wherein the ghost image is obtained by multiplying the brightness distribution of a primitive ghost image by a specific number, and the specific number is determined by the exposure time, the film speed, and the aperture size of the image capturing module when the image capturing module is capturing the image.

8. The method for image processing of claim 7, wherein the primitive ghost image is captured by the image capturing module when the light source is turned on and the lens cover faces a scene without reflectivity.

9. The method for image processing of claim 5, further comprising the step of increasing the brightness contrast of the result image after the result image is obtained.

10. A method for image processing, comprising:
providing an image capturing device, wherein a light source and an image capturing module of the image capturing device are disposed in an accommodating space formed by a case and a lens cover;
moving the image capturing device, such that the lens cover faces a scene without reflectivity;
turning on the light source;
capturing a primitive ghost image by the image capturing module through the lens cover: and
saving the primitive ghost image in the image capturing device.

11. The method for image processing of claim 10, further comprising:
orienting the image capturing device to face an object;
capturing an image by the image capturing module through the lens cover; and
obtaining a result image by subtracting the brightness distribution of the primitive ghost image multiplied by a specific number from the brightness distribution of the image, wherein the specific number is determined by the exposure time, the film speed, and the aperture size of the image capturing module when the image capturing module is capturing the image.

12. The method for image processing of claim 10, further comprising the step of increasing the brightness contrast of the result image after the result image is obtained.
